(19) United States
(12) Patent Application Publication
(10) Pub. No.: US 2021/0141326 A1
(43) Pub. Date: May 13, 2021

(54) IMAGE FORMING APPARATUS AND NON-TRANSITORY COMPUTER READABLE MEDIUM

(71) Applicant: FUJI XEROX CO., LTD., Tokyo (JP)

(72) Inventors: Takumi NISHIKATA, Kanagawa (JP); Yuzo FUJITA, Kanagawa (JP); Eiichi WAIDA, Kanagawa (JP)

(73) Assignee: FUJI XEROX CO., LTD., Tokyo (JP)

(21) Appl. No.: 16/864,410

(22) Filed: May 1, 2020

(30) Foreign Application Priority Data
Nov. 7, 2019 (JP) 2019-202023

(51) Int. Cl. G03G 15/00

(52) U.S. Cl. CPC G03G 15/50

(57) ABSTRACT

An image forming apparatus includes first and second processors. The first processor controls a transport device transporting a sheet and a first image forming section forming an image on the sheet. The second processor controls a second image forming section forming an image on the sheet. If an image is to be formed at the second section, the first processor transmits, to the second processor, a preparation command. Then upon receipt and completed preparation in the second section, the second processor transmits a completion notification to the first processor. Then, the first processor causes the first section to perform image formation preparation and causes the transport device to transport the sheet if an image is to be formed at the first section, or causes the transport device to transport the sheet without causing the first section to perform the preparation if an image is not to be formed there.

### CROSS-REFERENCE TO RELATED APPLICATIONS

This application is based on and claims priority under 35 USC 119 from Japanese Patent Application No. 2019-202023 filed Nov. 7, 2019.

### BACKGROUND

### (i) Technical Field

The present disclosure relates to image forming apparatuses and non-transitory computer readable media.

### (ii) Related Art

For example, Japanese Unexamined Patent Application Publication No. 2012-030388 describes a print control device configured as follows. Specifically, the print control device is provided in a printer equipped with multiple print controllers and a drive controller. The print controllers perform control of a print unit in a role-sharing manner. The drive controller drives and controls a mechanical mechanism for printing based on a command from each of the print controllers. The print control device includes an input unit that receives a first command, a command generating unit that generates a second command inside the print control device, a managing unit that manages the first and second commands in the order in which they are acquired, a command unit that outputs the first and second commands in the order in which they are managed, an output unit that outputs the commands received from the command unit to the drive controller, and a synchronizing unit that outputs the commands to the output unit when the commands are available in the output unit in each of the multiple print controllers. The output unit determines whether the command received from the command unit is the first command or the second command. If the received command is the first command, the output unit outputs the first command in synchronization with the synchronizing unit. If the received command is the second command, the output unit outputs the second command out of synchronization with the synchronizing unit.

### SUMMARY

For example, in a single image forming apparatus having a single housing, the single housing contains therein two image forming sections that form images on a single sheet and two controllers that respectively control the two image forming sections. It is conceivable that one of the controllers is configured to perform control for transporting the sheet. In the case of such a configuration, if an image formation command for forming images at the two image forming sections is received, the two image forming sections have to prepare for an image forming process (sometimes referred to as “image formation preparation” hereinafter). It is conceivable that a first one of the controllers may start a sheet transporting process and image formation preparation for an image forming section that the first controller controls after receiving a notification from a second one of the controllers indicating that the image formation preparation is completed.

However, if the received image formation command is sufficient by simply forming an image at the second image forming section alone, the first controller does not have to perform the image formation preparation. Thus, when the first controller performs the image formation preparation together with the sheet transporting process, electric power for the image formation preparation is wastefully consumed.

Aspects of non-limiting embodiments of the present disclosure relate to an image forming apparatus in which, if an image does not have to be formed at one of two image forming sections, the amount of electric power consumed for image formation preparation may be reduced, as compared with a configuration where the two image forming sections both perform the image formation preparation.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including a first processor and a second processor. The first processor controls a transport device that transports a sheet and a first image forming section that forms an image on the sheet transported by the transport device. The second processor controls a second image forming section that forms an image on the sheet transported by the transport device. If an image is to be formed at the second image forming section, the first processor transmits, to the second processor, a preparation command for performing image formation preparation in the second image forming section. After the second processor receives the preparation command, the second processor transmits a completion notification to the first processor when the image formation preparation in the second image forming section is completed. After the first processor receives the completion notification, the first processor causes the first image forming section to perform image formation preparation and causes the transport device to transport the sheet if an image is to be formed at the first image forming section, or causes the transport device to transport the sheet without causing the first image forming section to perform the image formation preparation if an image is not to be formed at the first image forming section.

### BRIEF DESCRIPTION OF THE DRAWINGS

Exemplary embodiments of the present disclosure will be described in detail based on the following figures, wherein:

FIG. 1 illustrates an example of a schematic configuration of the internal structure of an image forming apparatus according to an exemplary embodiment;

FIG. 2 is a block diagram illustrating an example of a hardware configuration of a first controller and a second controller;

FIG. 3 illustrates an example of a process performed by the first controller and the second controller;

FIG. 4 illustrates an example of a process performed when an image does not have to be formed at a second image forming section;

FIG. 5 illustrates an example of a process performed when an image does not have to be formed at a first image forming section;

FIG. 6 illustrates another example of the process performed when an image does not have to be formed at the first image forming section;

FIG. 7 is a flowchart illustrating an example of a process performed by a first master controller; and

FIG. 8 is a flowchart illustrating an example of a process performed by a second master controller.

### DETAILED DESCRIPTION

Exemplary embodiments of the present disclosure will be described below with reference to the appended drawings.

FIG. 1 illustrates an example of a schematic configuration of the internal structure of an image forming apparatus 1 according to an exemplary embodiment.

The image forming apparatus 1 includes a first image forming section 10 that forms an image on a sheet as an example of a recording medium and a second image forming section 20 that forms an image on the sheet. The image forming apparatus 1 also includes a sheet container 30 that contains sheets and a sheet transport device 40 that transports each sheet contained in the sheet container 30 to, for example, the first image forming section 10. Moreover, the image forming apparatus 1 includes a fixing device 50 that fixes a toner image formed on the sheet onto the sheet by applying heat and pressure thereto, a sheet load section 60 on which the sheet having the image formed thereon as a result of the toner image being fixed thereon by the fixing device 50 is loaded, and a user interface (sometimes referred to as “UI” hereinafter) 70 that displays information. The image forming apparatus 1 also includes a first controller 100 that controls, for example, the first image forming section 10, the sheet transport device 40, and the fixing device 50, and also includes a second controller 200 that controls the second image forming section 20.

The first image forming section 10 includes four image forming units 11 that are arranged side-by-side at a fixed interval and that form toner images of colors of contained toners. Each image forming unit 11 includes a photoconductor drum 12 that retains a toner image, a charging device 13 that electrostatically charges the surface of the photoconductor drum 12, and a light-emitting-diode (LED) print head 14 that forms an electrostatic latent image on the photoconductor drum 12 by exposing the photoconductor drum 12 electrostatically charged by the charging device 13 with light based on image data for the corresponding color. Each image forming unit 11 also includes a developing device 15 that develops the electrostatic latent image formed on the photoconductor drum 12, and also includes a drum cleaner 16 that cleans the photoconductor drum 12 after a transfer process. In the four image forming units 11 according to this exemplary embodiment, the developing devices 15 thereof contain yellow (Y), magenta (M), cyan (C), and black (K) toners, respectively, and form toner images of the respective colors.

Furthermore, the first image forming section 10 includes an intermediate transfer belt 17 onto which the toner images of the respective colors formed at the photoconductor drums 12 of the image forming units 11 are superposed and transferred. Moreover, the first image forming section 10 includes first-transfer rollers 18 that sequentially transfer (first-transfer) the toner images of the respective colors formed at the image forming units 11 onto the intermediate transfer belt 17, and also includes a second-transfer roller 19 that collectively transfers (second-transfers) the toner images of the respective colors superposed and transferred on the intermediate transfer belt 17 onto a sheet.

Similar to the first image forming section 10, the second image forming section 20 includes four image forming units 21, an intermediate transfer belt 27, first-transfer rollers 28, and a second-transfer roller 29. Similar to the image forming units 11, the image forming units 21 each include a photoconductor drum 22, a charging device 23, an LED print head 24, a developing device 25, and a drum cleaner 26. In the four image forming units 21 according to this exemplary embodiment, the developing devices 25 contain white, gold, silver, and clear toners and form toner images of the respective colors. The colors of the toners contained in the developing devices 25 of the image forming units 21 are not limited to the aforementioned colors. For example, red, blue, and green colors may be used.

The sheet transport device 40 includes an upper roller 41 and a lower roller 42 disposed apart from each other in the vertical direction, and also includes a transport belt 43 wrapped around the upper roller 41 and the lower roller 42. Furthermore, the sheet transport device 40 includes a feed roller 44 that feeds each sheet contained in the sheet container 30 toward the transport belt 43, and also includes a transport roller 45 disposed between the feed roller 44 and the transport belt 43. The sheet transport device 40 also includes multiple sensors 46 that detect the passing of a transported sheet.

The fixing device 50 includes a heating roller 51 that heats a transported sheet, and also includes a belt module 52 that is pressed against the heating roller 51 and forms a pressure unit together with the heating roller 51. The fixing device 50 applies heat and pressure, at the pressure unit, onto a sheet having a toner image, so as to fix the toner image onto the sheet.

The UI 70 is, for example, a display panel that receives information from a user and that displays information to the user.

The image forming apparatus 1 having the above-described configuration operates as follows.

The toner images of the four colors formed on the photoconductor drums 12 in the image forming units 11 of the first image forming section 10 are first-transferred onto the intermediate transfer belt 17 by the first-transfer rollers 18, so that a superposed toner image constituted of the superposed toners of the four colors is formed on the intermediate transfer belt 17. Then, as the intermediate transfer belt 17 moves, the superposed toner image on the intermediate transfer belt 17 is transported to a second-transfer unit where the second-transfer roller 19 is disposed.

When the superposed toner image of the first image forming section 10 is transported to the second-transfer unit, a sheet is fed from the sheet container 30 to the second-transfer unit in accordance with this timing. Then, at the second-transfer unit, the superposed toner image is collectively second-transferred onto the transported sheet in accordance with a transfer electric field produced by the second-transfer roller 19.

The toner images of the remaining four colors formed on the photoconductor drums 22 in the image forming units 21 of the second image forming section 20 are first-transferred onto the intermediate transfer belt 27 by the first-transfer rollers 28, so that a superposed toner image constituted of the superposed toners of the remaining four colors is formed on the intermediate transfer belt 27. Then, as the intermediate transfer belt 27 moves, the superposed toner image on the intermediate transfer belt 27 is transported to a second-transfer unit where the second-transfer roller 29 is disposed.

When the superposed toner image of the second image forming section 20 is transported to the second-transfer unit, the sheet having the superposed toner image electrostatically transferred thereon at the first image forming section 10 is fed to this second-transfer unit in accordance with this timing. Then, at the second-transfer unit, the superposed toner image of the second image forming section 20 is collectively second-transferred onto the superposed toner image on the transported sheet, having the superposed toner image electrostatically transferred thereon at the first image forming section 10, in accordance with a transfer electric field produced by the second-transfer roller 29.

Subsequently, the sheet having electrostatically transferred thereon a superposed toner image constituted of the superposed toner image of the first image forming section 10 and the superposed toner image of the second image forming section 20 is transported to the fixing device 50. The toner image on the sheet transported to the fixing device 50 receives heat and pressure applied by the fixing device 50, so as to be fixed onto the sheet. Then, the sheet having the fixed image thereon is transported to the sheet load section 60 of the image forming apparatus 1.

FIG. 2 is a block diagram illustrating an example of a hardware configuration of the first controller 100 and the second controller 200.

### First Controller 100

The first controller 100 includes a first master controller 110 that controls the operation of, for example, the first image forming section 10, the sheet transport device 40, and the fixing device 50, and also includes a first slave controller 120 that controls the operation of these devices under the control of the first master controller 110.

The first master controller 110 includes a central processing unit (CPU) 111, a read-only memory (ROM) 112, a random access memory (RAM) 113, a storage unit 114, such as a semiconductor memory, and a communication unit 115 used for communicating with an external device. The communication unit 115 may be a communication interface (I/F).

The ROM 112 stores therein a basic program (operation system) executed by the CPU 111, as well as various settings. The CPU 111 uses the RAM 113 as a work area and executes programs read from the ROM 112 and the storage unit 114. The CPU 111 executes the programs so that functions of the first master controller 110 to be described below are realized.

The first master controller 110 exchanges information with the first slave controller 120, the second controller 200, and the UI 70 via the communication unit 115.

Furthermore, the first master controller 110 receives an image formation command from, for example, a user terminal (such as a personal computer (PC)) used by the user via the communication unit 115. The first master controller 110 analyzes the received image formation command. The image formation command contains image data as data of an image to be formed, as well as designated image formation settings. Examples of the image formation settings include the size and the material of a sheet on which the image is to be formed, and the colors of colorants to be used.

The first master controller 110 also performs predetermined image processing on the received image data. The first master controller 110 converts the image data into YMCK data with respect to the reproduction colors of the first image forming section 10, that is, the colors (yellow (Y), magenta (M), cyan (C), and black (K)) of the toners serving as the colorants of the first image forming section 10, and outputs the YMCK data. The YMCK data is constituted of Y-color data, M-color data, C-color data, and K-color data that are separated from one another for the respective colors. The first master controller 110 also counts the number of pieces of the Y-color data, the M-color data, the C-color data, and the K-color data.

Furthermore, the first master controller 110 notifies the first slave controller 120 of the size and the material of the sheet according to the received image formation command.

Similar to the first master controller 110, the first slave controller 120 includes a CPU 121, a ROM 122, a RAM 123, a storage unit 124, and a communication unit 125. The CPU 121 uses the RAM 123 as a work area and executes programs read from the ROM 122 and the storage unit 124, so that functions of the first slave controller 120 to be described below are realized.

The first slave controller 120 exchanges control information with the first master controller 110 so as to perform control of, for example, exposure, development, and transfer processes in the first image forming section 10, feed and transport processes of a sheet by the sheet transport device 40 in accordance with a transfer timing, and a toner-image fixing process by the fixing device 50.

Furthermore, the first slave controller 120 acquires information about an error, such as a toner shortage in the first image forming section 10 or a paper jam in the sheet transport device 40. The first slave controller 120 notifies the first master controller 110 of this error information. The first master controller 110 notifies the user of this error information by displaying the error information on the display panel of the UI 70. Then, for example, if the error is a toner shortage, the first slave controller 120 acquires information indicating that the error has been resolved when the toner is resupplied. If the error is a paper jam, for example, the first slave controller 120 acquires information indicating that the error has been resolved when the paper jam is removed. Then, the first slave controller 120 notifies the first master controller 110 that the error has been resolved. The first master controller 110 notifies the user that the error has been resolved by displaying a message on the display panel of the UI 70.

### Second Controller 200

The second controller 200 includes a second master controller 210 that controls the operation of the second image forming section 20, and also includes a second slave controller 220 that controls the operation of the second image forming section 20 under the control of the second master controller 210.

The second master controller 210 includes a CPU 211, a ROM 212, a RAM 213, a storage unit 214, such as a semiconductor memory, and a communication unit 215 used for communicating with an external device.

The ROM 212 stores therein a basic program (operation system) executed by the CPU 211, as well as various settings. The CPU 211 uses the RAM 213 as a work area and executes programs read from the ROM 212 and the storage unit 214. The CPU 211 executes the programs so that functions of the second master controller 210 to be described below are realized.

The second master controller 210 exchanges information with the second slave controller 220, the first controller 100, and the UI 70 via the communication unit 215.

Furthermore, the second master controller 210 receives an image formation command from, for example, a user terminal (such as a PC) via the communication unit 215. The second master controller 210 analyzes the received image formation command. The image formation command contains image data as data of an image to be formed, as well as designated image formation settings.

The second master controller 210 also performs predetermined image processing on the received image data. The second master controller 210 converts the image data into white-color data, gold-color data, silver-color data, and clear data with respect to the reproduction colors of the second image forming section 20, that is, the colors (white, gold, silver, and clear) of the toners serving as the colorants of the second image forming section 20, and outputs the white-color data, the gold-color data, the silver-color data, and the clear data. The second master controller 210 also counts the number of pieces of the white-color data, the gold-color data, the silver-color data, and the clear data.

Moreover, the second master controller 210 notifies the second slave controller 220 of the size and the material of the sheet according to the received image formation command.

The second slave controller 220 includes a CPU 221, a ROM 222, a RAM 223, a storage unit 224, and a communication unit 225. The CPU 221 uses the RAM 223 as a work area and executes programs read from the ROM 222 and the storage unit 224, so that functions of the second slave controller 220 to be described below are realized.

The second slave controller 220 exchanges control information with the second master controller 210 so as to perform control of, for example, exposure, development, and transfer processes in the second image forming section 20.

Furthermore, the second slave controller 220 acquires information about an error, such as a toner shortage in the second image forming section 20. The second slave controller 220 notifies the second master controller 210 of this error information. The second master controller 210 notifies the user of this error information by displaying the error information on the display panel of the UI 70. Then, for example, if the error is a toner shortage, the second slave controller 220 acquires information indicating that the error has been resolved when the toner is resupplied. Then, the second slave controller 220 notifies the second master controller 210 that the error has been resolved. The second master controller 210 notifies the user that the error has been resolved by displaying a message on the display panel of the UI 70.

### Collaborative Operation Between First Controller 100 and Second Controller 200

The first controller 100 and the second controller 200 exchange information with each other after activation, cause the first image forming section 10 to second-transfer the four-color superposed toner image onto a sheet transported by the sheet transport device 40 operating under the control of the first controller 100, and cause the second image forming section 20 to second-transfer the other four-color superposed toner image onto the sheet. The expression “the first image forming section 10 second-transfers the four-color superposed toner image onto the sheet” may sometimes be expressed as “the first image forming section 10 forms an image” hereinafter. The expression “the second image forming section 20 second-transfers the other four-color superposed toner image onto the sheet” may sometimes be expressed as “the second image forming section 20 forms an image” hereinafter.

The process performed by the first controller 100 and the second controller 200 will be described below.

FIG. 3 illustrates an example of the process performed by the first controller 100 and the second controller 200.

When the first master controller 110 receives an image formation command from, for example, a user terminal via the communication unit 115 in step S301, the first master controller 110 notifies the first slave controller 120 of designated image formation settings in step S302. Consequently, the first slave controller 120 acquires the image formation settings in step S303.

Subsequently, the first master controller 110 determines in step S304 whether or not an error, such as a toner shortage or a paper jam, has occurred in the first image forming section 10. If an error has not occurred (NO in step S304), the first master controller 110 transmits, to the second master controller 210, a preparation command for performing image formation preparation in the second image forming section 20 in step S305. If an error has occurred (YES in step S304), the first master controller 110 waits until the error is resolved.

In step S306, the second master controller 210 receives the preparation command transmitted from the first master controller 110. Then, if the image formation command is received from, for example, the user terminal via the communication unit 215 in step S307, the second master controller 210 notifies the first slave controller 120 of the image formation settings in step S308. Consequently, the second slave controller 220 acquires the image formation settings in step S309. Alternatively, the reception of the image formation command in step S307 may be performed prior to the reception of the preparation command from the first master controller 110 in step S306.

Subsequently, the second master controller 210 determines in step S310 whether or not an error, such as a toner shortage, has occurred in the second image forming section 20. If an error has not occurred (NO in step S310), the second master controller 210 notifies the second slave controller 220 of the preparation command for performing the image formation preparation in the second image forming section 20 in step S311. After acquiring the preparation command in step S312, the second slave controller 220 commands the second image forming section 20 to perform the image formation preparation in step S313. The image formation preparation involves performing preparation when an image forming section is to form an image, and includes, for example, a warm-up process of the developing devices 25, an image-quality adjustment process, and a process for spontaneously disposing deteriorated toners. All of these processes consume electric power and some may consume toner. When the image formation preparation is completed, the second image forming section 20 is set on standby. In contrast, if an error has occurred (YES in step S310), the second master controller 210 waits until the error is resolved.

When the image formation preparation in the second image forming section 20 is completed, the second master controller 210 transmits a completion notification indicating that the preparation has been completed to the first master controller 110 in step S314. Alternatively, after giving the command for performing image formation preparation in step S313, the second master controller 210 may determine that the image formation preparation in the second image forming section 20 is completed when the second master controller 210 receives a notification indicating that the preparation has been completed from the second image forming section 20. As another alternative, after giving the command for performing image formation preparation in step S313, the second master controller 210 may determine that the image formation preparation in the second image forming section 20 is completed when a predetermined time period elapses.

After receiving the completion notification from the second master controller 210 in step S315, the first master controller 110 notifies the first slave controller 120 of a preparation command for performing image formation preparation in the first image forming section 10 in step S316. After acquiring the preparation command in step S317, the first slave controller 120 commands the first image forming section 10 to perform the image formation preparation in step S318. The image formation preparation includes, for example, a warm-up process of the developing devices 15, an image-quality adjustment process, and a process for spontaneously disposing deteriorated toners. When the image formation preparation is completed, the first image forming section 10 is set on standby.

When the image formation preparation in the first image forming section 10 is completed, the first slave controller 120 causes the sheet transport device 40 to start transporting a sheet in step S319, and causes the first image forming section 10 to form an image on the transported sheet in step S320. Alternatively, after giving the command for performing image formation preparation in step S316, the first master controller 110 may determine that the image formation preparation in the first image forming section 10 is completed when the first master controller 110 receives a notification indicating that the preparation has been completed from the first image forming section 10. As another alternative, after giving the command for performing image formation preparation in step S316, the first master controller 110 may determine that the image formation preparation in the first image forming section 10 is completed when a predetermined time period elapses.

In step S321, the second slave controller 220 causes the second image forming section 20 to form an image on the transported sheet.

Then, the first slave controller 120 causes the fixing device 50 to fix the toner image on the transported sheet onto the sheet and to output the sheet having undergone the fixing process onto the sheet load section 60, and completes the image forming process in step S322.

Subsequently, in step S323, the first slave controller 120 notifies the first master controller 110 that the image forming process is completed. After acquiring the completion notification in step S324, the first master controller 110 transmits the completion notification indicating that the image forming process is completed to the second master controller 210 in step S325.

After receiving the completion notification in step S326, the second master controller 210 transmits information indicating that the completion notification is received to the first master controller 110 in step S327.

After receiving the information indicating the reception of the completion notification in step S328, the first master controller 110 ends the image forming operation in step S329. The end of the image forming operation includes an end of the toner-image forming process in the first image forming section 10 and a process for deleting current-image-formation-related information stored in the RAM 113 and the storage unit 114.

After transmitting the information indicating the reception of the completion notification to the first master controller 110 in step S327, the second master controller 210 ends the image forming operation in step S330. The end of the image forming operation includes an end of the toner-image forming process in the second image forming section 20 and a process for deleting current-image-formation-related information stored in the RAM 213 and the storage unit 214.

Accordingly, in this exemplary embodiment, the image forming operation is performed by causing the first controller 100 and the second controller 200 to operate collaboratively with each other.

For example, if an error has not occurred in the first image forming section 10 or the sheet transport device 40, serving as a target to be controlled by the first master controller 110, the first master controller 110 transmits, to the second master controller 210, a preparation command for performing image formation preparation in the second image forming section 20 in step S305. After receiving this preparation command in step S306, the second master controller 210 notifies the second slave controller 220 of the preparation command for performing the image formation preparation in the second image forming section 20 in step S311 if an error has not occurred in the second image forming section 20, serving as a target to be controlled by the second master controller 210. When the image formation preparation in the second image forming section 20 is completed, the second master controller 210 transmits a completion notification indicating that the preparation has been completed to the first master controller 110 in step S314. After receiving the completion notification in step S315, the first master controller 110 notifies the first slave controller 120 of a preparation command for performing image formation preparation in the first image forming section 10 in step S316.

Accordingly, a time lag between the timing at which the first image forming section 10 starts an image forming process and the timing at which the second image forming section 20 starts an image forming process may be suppressed. This time lag may be caused when, for example, the first controller 100 and the second controller 200 operate independently of each other instead of collaboratively with each other. For example, a situation where an image forming process by the second image forming section 20 is not performed in time may be suppressed. Such a situation may occur when a sheet transport process is started by the sheet transport device 40 or an image forming process is started by the first image forming section 10 regardless of the fact that the image formation preparation in the second image forming section 20 is still not completed.

Moreover, a situation where electric power is wastefully consumed due to the second image forming section 20 being on standby for a long period of time regardless of the fact that an error has occurred in the first image forming section 10 or the sheet transport device 40 may be suppressed. Furthermore, a situation where electric power is wastefully consumed due to the first image forming section 10 being on standby for a long period of time regardless of the fact that an error has occurred in the second image forming section 20 may be suppressed.

In this exemplary embodiment, when an image forming process is completed, the first master controller 110 transmits, to the second master controller 210 in step S325, a completion notification indicating that the image forming process is completed. Then, after receiving the completion notification in step S326, the second master controller 210 transmits information indicating the reception of the completion notification to the first master controller 110 in step S327.

Consequently, a situation where the second controller 200 is not able to ascertain that the fixing process by the fixing device 50 is completed and that the image forming process is completed due to the first controller 100 and the second controller 200 operating independently of each other may be suppressed.

It is conceivable that the image formation command from, for example, the user terminal is sufficient by simply performing an image forming process only at one of the first image forming section 10 and the second image forming section 20 and does not require performing an image forming process at the other image forming section. Examples include a case where the image formation command is for forming an image using a toner of a single color among the yellow (Y), magenta (M), cyan (C), and black (K) toners provided in the first image forming section 10 and a case where the image formation command is for forming an image using a toner of a single color among the white, gold, silver, and clear toners provided in the second image forming section 20. Another example is a case where the user uses the user terminal to designate that an image is to be formed only at either one of the first image forming section 10 and the second image forming section 20 via a printer driver.

In view of such circumstances, the first controller 100 and the second controller 200 perform control as follows.

FIG. 4 illustrates an example of a process performed when an image does not have to be formed at the second image forming section 20. Steps that are identical to the steps shown in FIG. 3 are given the same reference signs, and descriptions thereof will be omitted.

After receiving an image formation command from, for example, a user terminal, the second master controller 210 analyzes this image formation command so as to count the number of pieces of white-color data, gold-color data, silver-color data, and clear data. If the count number of these pieces of data are all zero, step S308, step S310, and step S311 described above are omitted.

Specifically, after the second master controller 210 receives the preparation command transmitted by the first master controller 110 in step S306, if the number of pieces of the white-color data, the gold-color data, the silver-color data, and the clear data related to the received image formation command are all zero, the second master controller 210 transmits a completion notification indicating that the preparation is completed to the first master controller 110 in step S314, without performing step S308, step S310, or step S311.

Consequently, the second master controller 210 does not notify the second slave controller 220 of a preparation command for performing image formation preparation in the second image forming section 20. As a result, since the second slave controller 220 does not command the second image forming section 20 to perform image formation preparation, electric power for image formation preparation is not wastefully consumed.

Alternatively, the second master controller 210 may notify the second slave controller 220 that image formation preparation is not to be performed in the second image forming section 20, instead of omitting the notification to the second slave controller 220 in step S311.

FIG. 5 illustrates an example of a process performed when an image does not have to be formed at the first image forming section 10. Steps that are identical to the steps shown in FIG. 3 are given the same reference signs, and descriptions thereof will be omitted.

After receiving an image formation command from, for example, a user terminal, the first master controller 110 analyzes this image formation command so as to count the number of pieces of Y-color data, M-color data, C-color data, and K-color data. If the count number of these pieces of data are all zero, the first master controller 110 notifies the first slave controller 120 in step S516 that image formation preparation is not to be performed, instead of notifying the first slave controller 120 of a preparation command for performing image formation preparation in the first image forming section 10 in step S316. However, since an image has to be formed at the second image forming section 20, the first master controller 110 notifies the first slave controller 120 in step S516 of a command for causing the sheet transport device 40 to transport a sheet.

Consequently, after acquiring the notification in step S517 indicating that image formation preparation is not to be performed, the first slave controller 120 does not command the first image forming section 10 to perform image formation preparation, so that electric power for image formation preparation is not wastefully consumed. In order to form an image at the second image forming section 20, the first slave controller 120 causes the sheet transport device 40 to start transporting a sheet in step S319.

Then, the first slave controller 120 causes the fixing device 50 to fix the toner image on the transported sheet onto the sheet and to output the sheet having undergone the fixing process onto the sheet load section 60, and completes the image forming process in step S322.

FIG. 6 illustrates another example of the process performed when an image does not have to be formed at the first image forming section 10. Steps that are identical to the steps shown in FIG. 3 are given the same reference signs, and descriptions thereof will be omitted.

If the user designates that an image is to be formed only at the second image forming section 20 via the printer driver, an image formation command received by the second master controller 210 contains information indicating that an image forming process is to be performed only at the second image forming section 20 and that an image forming process is not to be performed at the first image forming section 10. In such a case, it is conceivable that the first master controller 110 does not receive the image formation command. As mentioned above, the first master controller 110 does not transmit a preparation command for the second image forming section 20 to the second master controller 210 unless the first master controller 110 receives an image formation command. Then, as mentioned above, since the second master controller 210 notifies the second slave controller 220 of the preparation command for the second image forming section 20 after receiving the preparation command from the first master controller 110, an image is not formable at the second image forming section 20, regardless of the fact that an image has to be formed at the second image forming section 20. The first master controller 110 is not able to cause the sheet transport device 40 to transport a sheet unless the first master controller 110 receives an image formation command.

In view of the circumstances described above, if the second master controller 210 receives, in step S651, an image formation command containing information indicating that an image forming process is to be performed only at the second image forming section 20 before receiving a preparation command from the first master controller 110 in step S306, the second master controller 210 operates as follows.

In step S652, the second master controller 210 requests the first master controller 110 to not perform an image forming process at the first image forming section 10 but to notify the first slave controller 120 that other image-formation-related processes, such as a sheet transporting process by the sheet transport device 40, are to be performed.

After receiving the notification request from the second master controller 210 in step S653, the first master controller 110 performs the process from step S302 and onward. Then, after receiving a completion notification from the second master controller 210 in step S315, the first master controller 110 notifies the first slave controller 120 in step S516 that an image forming process is not to be performed at the first image forming section 10 but other image-formation-related processes, such as a sheet transporting process by the sheet transport device 40, are to be performed. The notification of the command for causing the sheet transport device 40 to transport a sheet is provided because an image has to be formed at the second image forming section 20.

Consequently, after acquiring the notification in step S517 indicating that image formation preparation is not to be performed, the first slave controller 120 does not command the first image forming section 10 to perform image formation preparation, so that electric power for image formation preparation is not wastefully consumed. In order to form an image at the second image forming section 20, the first slave controller 120 causes the sheet transport device 40 to start transporting a sheet in step S319.

Then, the first slave controller 120 causes the fixing device 50 to fix the toner image on the transported sheet onto the sheet and to output the sheet having undergone the fixing process onto the sheet load section 60, and completes the image forming process in step S322.

A process performed by the first master controller 110 according to this exemplary embodiment will be described below with reference to a flowchart.

FIG. 7 is a flowchart illustrating an example of the process performed by the first master controller 110. The first master controller 110 repeats this process at predetermined time intervals (such as every 1 millisecond).

In step S701, the first master controller 110 determines whether or not an image formation command is received from, for example, a user terminal. If an image formation command is received (YES in step S701), the first master controller 110 notifies the first slave controller 120 of the designated image formation settings in step S702.

Subsequently, in step S703, it is determined whether or not an error has occurred. If an error has not occurred (NO in step S703), the first master controller 110 transmits, to the second master controller 210, a preparation command for performing image formation preparation in the second image forming section 20 in step S704. In contrast, if an error has occurred (YES in step S703), the first master controller 110 waits until the error is resolved. Step S703 and step S704 respectively correspond to step S304 and step S305 described with reference to FIG. 3.

Subsequently, in step S705, the first master controller 110 determines whether or not a completion notification is received from the second master controller 210. If a completion notification is received (YES in step S705 (corresponding to step S315 described with reference to FIG. 3)), it is determined in step S706 whether or not an image has to be performed at the first image forming section 10. In contrast, if a completion notification is not received (NO in step S705), the first master controller 110 waits until receiving a completion notification.

If an image has to be formed at the first image forming section 10 (YES in step S706), the first master controller 110 notifies the first slave controller 120 of a preparation command for performing image formation preparation in the first image forming section 10 in step S707. Step S707 corresponds to step S316 described with reference to FIG. 3.

In contrast, if an image does not have to be formed at the first image forming section 10 (NO in step S706), the first master controller 110 provides a notification indicating that image formation preparation is not to be performed in the first image forming section 10 in step S708. Step S708 corresponds to step S516 described with reference to FIG. 5. However, since an image has to be formed at the second image forming section 20, the first master controller 110 notifies the first slave controller 120 of a command for causing the sheet transport device 40 to transport a sheet.

Subsequently, in step S709, the first master controller 110 determines whether or not a completion notification indicating that the image forming process is completed is acquired from the first slave controller 120. If a completion notification is acquired (YES in step S709), the first master controller 110 transmits the completion notification indicating that the image forming process is completed to the second master controller 210 in step S710. Step S710 corresponds to step S325 described with reference to FIG. 3.

Subsequently, in step S711, the first master controller 110 determines whether or not information indicating the reception of the completion notification by the second master controller 210 is received therefrom. If the information indicating the reception of the completion notification is received (YES in step S711 (corresponding to step S328 described with reference to FIG. 3)), the first master controller 110 ends the image forming operation in step S712. In contrast, if the information indicating the reception of the completion notification is not received (NO in step S712), the first master controller 110 waits until receiving the information.

If an image formation command is not received in step S701 (NO in step S701), the first master controller 110 determines in step S713 whether or not a notification request for not performing an image forming process at the first image forming section 10 but for performing other image-formation-related processes is received from the second master controller 210. If a notification request is received from the second master controller 210 (YES in step S713 (corresponding to step S653 described with reference to FIG. 6)), the first master controller 110 notifies the first slave controller 120 of the designated image formation settings, such as the sheet settings, in step S714.

Subsequently, in step S715, it is determined whether or not an error, such as a paper jam, has occurred in the sheet transport device 40. If an error has not occurred (NO in step S715), the first master controller 110 transmits, to the second master controller 210, a preparation command for performing image formation preparation in the second image forming section 20 in step S716. In contrast, if an error has occurred (YES in step S715), the first master controller 110 waits until the error is resolved.

In step S717, the first master controller 110 determines whether or not a completion notification is received from the second master controller 210. Then, if a completion notification is received (YES in step S717), the process from step S708 and onward is performed.

In contrast, if a completion notification is not received from the second master controller 210 (NO in step S713), the process ends.

A process performed by the second master controller 210 according to this exemplary embodiment will be described below with reference to a flowchart.

FIG. 8 is a flowchart illustrating an example of the process performed by the second master controller 210. The second master controller 210 repeats this process at predetermined time intervals (such as every 1 millisecond).

In step S801, the second master controller 210 determines whether or not an image formation command is received from, for example, a user terminal. If an image formation is received (YES in step S801 (corresponding to step S651 described with reference to FIG. 6 or step S307 described with reference to FIG. 3)), the second master controller 210 determines in step S802 whether or not the image formation command contains information indicating that an image forming process is to be performed only at the second image forming section 20. Then, if the image formation command contains information indicating that an image forming process is to be performed only at the second image forming section 20 (YES in step S802), the second master controller 210 requests the first master controller 110 in step S803 to not perform an image forming process at the first image forming section 10 but to notify the first slave controller 120 that other image-formation-related processes, such as a sheet transporting process, are to be performed. Step 5803 corresponds to step S652 described with reference to FIG. 6.

Subsequently, in step S804, the second master controller 210 determines whether or not a preparation command is received from the first master controller 110. If a preparation command is received (YES in step S804 (corresponding to step S306 described with reference to FIG. 3)), the second master controller 210 notifies the second slave controller 220 of the designated image formation settings in step S805.

Subsequently, in step S806, it is determined whether or not an error has occurred in the second image forming section 20. Step S806 corresponds to step S310 described with reference to FIG. 3. If an error has not occurred (NO in step S806), it is determined in step S807 whether or not an image has to be formed at the second image forming section 20. In contrast, if an error has occurred (YES in step S806), the second master controller 210 waits until the error is resolved.

If an image has to be formed at the second image forming section 20 (YES in step S807), the second master controller 210 notifies the second slave controller 220 of the preparation command for performing image formation preparation in the second image forming section 20 in step S808. In contrast, if an image does not have to be formed at the second image forming section 20 (NO in step S807), the second master controller 210 notifies the second slave controller 220 in step S809 that image formation preparation is not to be performed in the second image forming section 20. Subsequently, in step S810, the second master controller 210 transmits a completion notification to the first master controller 110. Step S810 corresponds to step S314 described with reference to FIG. 3. If an image does not have to be formed at the second image forming section 20 (NO in step S807), the second master controller 210 may transmit a completion notification to the first master controller 110 without notifying the second slave controller 220 that image formation preparation is not to be performed in the second image forming section 20.

Subsequently, in step S811, the second master controller 210 determines whether or not a completion notification indicating that an image forming process is completed is received from the first master controller 110. If a completion notification is received (YES in step S811 (corresponding to step S326 described with reference to FIG. 3)), the second master controller 210 transmits information indicating the reception of the completion notification to the first master controller 110 in step S812. Step S812 corresponds to step S327 described with reference to FIG. 3. Then, the second master controller 210 ends the image forming operation in step S813. In contrast, if a completion notification is not received (NO in step S811), the second master controller 210 waits until receiving a completion notification.

If an image formation command is not received in step S801 (NO in step S801), the second master controller 210 determines in step S814 whether or not a preparation command is received from the first master controller 110. If a preparation command is received (YES in step S814 (corresponding to step S306 described with reference to FIG. 3)), the second master controller 210 performs the process from step S805 and onward, such as notifying the second slave controller 220 of the designated image formation settings. In contrast, if a preparation command is not received (NO in step S814), the second master controller 210 waits until receiving a preparation command.

In the exemplary embodiment above, the functions of the first controller 100 are executed by the CPU 111 of the first master controller 110 and the CPU 121 of the first slave controller 120 operating in cooperation with each other. However, the configuration is not particularly limited to that described above. For example, the functions of the first controller 100 may be realized by a single processor, or may be realized by using three or more processors. Likewise, in the exemplary embodiment above, the functions of the second controller 200 are executed by the CPU 211 of the second master controller 210 and the CPU 221 of the second slave controller 220 operating in cooperation with each other. However, the configuration is not particularly limited to that described above. For example, the functions of the second controller 200 may be realized by a single processor, or may be realized by using three or more processors. In the exemplary embodiment above, the term “processor” refers to hardware in a broad sense. Examples of the processor include general processors (e.g., CPU: Central Processing Unit), and dedicated processors (e.g., GPU: Graphics Processing Unit, ASIC: Application Integrated Circuit, FPGA: Field Programmable Gate Array, and programmable logic device).

The image forming apparatus 1 described above includes the CPU 111 and the CPU 121 as an example of a first processor configured to control the sheet transport device 40 serving as an example of a transport device that transports a sheet and the first image forming section 10 that forms an image on the sheet transported by the sheet transport device 40, and the CPU 211 and the CPU 221 as an example of a second processor configured to control the second image forming section 20 that forms an image on the sheet transported by the sheet transport device 40. If an image has to be formed at the second image forming section 20, the first processor transmits a preparation command for performing image formation preparation in the second image forming section 20 to the second processor in step S305. After receiving the preparation command in step S306, the second processor transmits a completion notification to the first processor in step S314 when the image formation preparation in the second image forming section 20 is completed. Then, after the first processor receives the completion notification in step S315, if an image has to be formed at the first image forming section 10, the first processor causes the first image forming section 10 to perform image formation preparation in step S318 and causes the sheet transport device 40 to transport a sheet in step S319. If an image is not to be formed at the first image forming section 10, the first processor causes the sheet transport device 40 to transport a sheet in step S319 without causing the first image forming section 10 to perform image formation preparation.

In the image forming apparatus 1 having the above-described configuration, if an image has to be formed at the first image forming section 10, the first processor causes the first image forming section 10 to perform image formation preparation after receiving a completion notification corresponding to a preparation command transmitted to the second processor for performing image formation preparation in the second image forming section 20. Thus, a situation where electric power is wastefully consumed due to the first image forming section 10 being on standby for a long period of time regardless of the fact that an error has occurred in the second image forming section 20 may be suppressed. Furthermore, if an image does not have to be formed at the first image forming section 10, the first processor does not cause the first image forming section 10 to perform image formation preparation. Consequently, for example, the amount of electric power consumed for the image formation preparation in the first image forming section 10 may be reduced, as compared with a configuration that causes the first image forming section 10 to perform image formation preparation even when an image does not have to be formed at, for example, the first image forming section 10.

The first processor may analyze an image formation command received from the outside, such as a user terminal, so as to determine that an image does not have to be formed at the first image forming section 10. Consequently, the first processor may accurately determine that an image does not have to be formed at the first image forming section 10, as compared with a case where, for example, the first processor receives a notification from the second processor.

For example, if the image formation command is for forming an image without using the toners provided in the first image forming section 10, the first processor may determine that an image does not have to be formed at the first image forming section 10. Accordingly, the first processor performs the determination based on the toners provided in the first image forming section 10, so that the determination may be performed accurately, as compared with a case where the determination is performed using elements other than the toners.

If the first processor receives a notification from the second processor indicating reception of an image formation command from the outside for forming an image at the second image forming section 20 but not necessary for forming an image at the first image forming section 10, the first processor may determine that an image does not have to be formed at the first image forming section 10. Consequently, the first processor may ascertain that an image formation command is received by the image forming apparatus 1 even if the first processor has not received the image formation command, and may cause a sheet to be transported for forming an image thereon at the second image forming section 20.

Furthermore, if an image formation command received from the outside is for forming an image using the toners provided in the second image forming section 20 without using the toners provided in the first image forming section 10, the second processor may transmit a notification to the first processor. Consequently, the first processor may cause a sheet to be transported for forming an image thereon at the second image forming section 20 even if the first processor has not received the image formation command.

The programs executed by the CPU 111 of the first master controller 110, the CPU 121 of the first slave controller 120, the CPU 211 of the second master controller 210, and the CPU 221 of the second slave controller 220 may each be provided by being stored in a computer-readable storage medium, such as a magnetic storage medium (e.g., magnetic tape or a magnetic disk), an optical storage medium (e.g., an optical disk), a magneto-optical storage medium, or a semiconductor memory, or may each be downloaded by using a communication unit, such as the Internet.

A program according to an exemplary embodiment of the disclosure causes the first processor, configured to control the sheet transport device 40 that transports a sheet and the first image forming section 10 that forms an image on the sheet transported by the sheet transport device 40, to transmit a preparation command to the second processor, configured to control the second image forming section 20, for performing image formation preparation in the second image forming section 20 if an image has to be formed at the second image forming section 20. The program also causes the second processor to transmit a completion notification to the first processor when the image formation preparation in the second image forming section 20 is completed after the second processor receives the preparation command. The program according to the exemplary embodiment of the disclosure also causes the first processor, after receiving the completion notification, to cause the first image forming section 10 to perform image formation preparation and to cause the sheet transport device 40 to transport a sheet if an image has to be formed at the first image forming section 10, or to cause the sheet transport device 40 to transport a sheet without causing the first image forming section 10 to perform image formation preparation if an image does not have to be formed at the first image forming section 10.

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
a first processor configured to control a transport device that transports a sheet and a first image forming section that forms an image on the sheet transported by the transport device; and
a second processor configured to control a second image forming section that forms an image on the sheet transported by the transport device,
wherein, if an image is to be formed at the second image forming section, the first processor transmits, to the second processor, a preparation command for performing image formation preparation in the second image forming section,
wherein, after the second processor receives the preparation command, the second processor transmits a completion notification to the first processor when the image formation preparation in the second image forming section is completed, and
wherein, after the first processor receives the completion notification, the first processor causes the first image forming section to perform image formation preparation and causes the transport device to transport the sheet if an image is to be formed at the first image forming section, or causes the transport device to transport the sheet without causing the first image forming section to perform the image formation preparation if an image is not to be formed at the first image forming section.

2. The image forming apparatus according to claim 1,
wherein the first processor analyzes an image formation command received from an outside so as to determine that an image is not to be formed at the first image forming section.

3. The image forming apparatus according to claim 2,
wherein, if the image formation command is a command for forming an image without using a colorant provided in the first image forming section, the first processor determines that an image is not to be formed at the first image forming section.

4. The image forming apparatus according to claim 1,
wherein, if the first processor receives a notification from the second processor indicating that the second processor has received an image formation command from an outside for forming an image at the second image forming section but not for forming an image at the first image forming section, the first processor determines that an image is not to be formed at the first image forming section.

5. The image forming apparatus according to claim 4,
wherein, if the image formation command received from the outside is a command for forming an image using a colorant provided in the second image forming section without using a colorant provided in the first image forming section, the second processor transmits the notification to the first processor.

6. A non-transitory computer readable medium storing a program causing a computer to execute a process, the process comprising:
causing a first processor to transmit a preparation command for performing image formation preparation in a second image forming section to a second processor if an image is to be formed at the second image forming section, the first processor being configured to control a transport device that transports a sheet and a first image forming section that forms an image on the sheet transported by the transport device, the second processor being configured to control the second image forming section;
causing the second processor to transmit a completion notification to the first processor when the image formation preparation in the second image forming section is completed after the second processor receives the preparation command; and
causing the first processor to cause the first image forming section to perform image formation preparation and to cause the transport device to transport the sheet, after the first processor receives the completion notification, if an image is to be formed at the first image forming section, or to cause the transport device to transport the sheet without causing the first image forming section to perform the image formation preparation, after the first processor receives the completion notification, if an image is not to be formed at the first image forming section.

7. An image forming apparatus comprising:
first processing means for controlling a transport device that transports a sheet and a first image forming section that forms an image on the sheet transported by the transport device; and
second processing means for controlling a second image forming section that forms an image on the sheet transported by the transport device,
wherein, if an image is to be formed at the second image forming section, the first processing means transmits, to the second processing means, a preparation command for performing image formation preparation in the second image forming section,
wherein, after the second processing means receives the preparation command, the second processing means transmits a completion notification to the first processing means when the image formation preparation in the second image forming section is completed, and
wherein, after the first processing means receives the completion notification, the first processing means causes the first image forming section to perform image formation preparation and causes the transport device to transport the sheet if an image is to be formed at the first image forming section, or causes the transport device to transport the sheet without causing the first image forming section to perform the image formation preparation if an image is not to be formed at the first image forming section.
